(19) United States
(12) Patent Application Publication
(10) Pub. No.: US 2004/0019589 A1
(43) Pub. Date: Jan. 29, 2004

(54) Driver for mapping standard database queries and commands to markup language documents

(76) Inventor: Rajesh G. Basrur, Superior, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/202,761

(22) Filed: Jul. 25, 2002

(51) Int. Cl. G06F 7/00

(52) U.S. Cl. 707/3

(57) ABSTRACT

A computer-based method for accessing a markup language document. The method includes receiving a data access request from an application that is in form of a database language statement and indicates a markup language document. The data access request is processed to identify the markup language document, and a communication connection is provided to the markup language document. The markup language document is then accessed or processed based on the database language statement. A result set is generated and returned to the application. Typically, the result set is in tabular form with data from the markup language document provided in rows and columns. The method includes dynamically mapping the markup language document to a database structure or records based on the received database language statement. Common tag prefixes in the statement are identified, and the elements in the document are grouped into records.

### BACKGROUND OF THE INVENTION

1. Field of the Invention

The present invention relates, in general, to managing access to data sources and, more particularly, to software, systems and methods for accessing markup language documents utilizing database language commands, such as structured query language (SQL) commands, that are more well known in the computer arts than specialized markup language document and document parser commands and functions.

2. Relevant Background

Documents prepared and stored according to a markup language have become the most widely accepted method of storing and manipulating data within heterogeneous and widely varying systems and networks because they allow data to be communicated using a common format and/or protocol. Markup languages use special codes, called markups or tags, in a document to specify how parts of the document are to be processed by an application. A number of markup languages have been developed and are used by the computer industry including the standard generalized markup language (SGML), the hypertext markup language (HTML), and extensible markup language (XML). Recently, XML has become the preferred markup language and is a pared-down version of SGML that is specifically designed for Web documents while providing more features and functions than HTML. XML defines a generic syntax used to markup data with simple, human-readable tags (i.e., strings of characters identified by a “<” prefix and a “>” suffix) to create standard computer documents. Each document is a combination of elements defined by data grouped together by tags and complying with a grammar specified by the particular markup language.

Because markup language documents comply with a well-defined grammar, the documents can be read and understood by parsers or using parsing methods adapted to the specific markup language. For example, a number of parsers or parser interfaces have been developed to facilitate access by applications to data in markup language documents. For example, in XML documents, Simple API for XML (i.e., SAX API) is a common interface implemented for or used by many different XML parsers and provides an event-driven approach to parsing XML documents. The SAX API is an interface for use with several programming languages including JAVA, C/C++, and perl that is particularly useful for reading large XML documents as the document is parsed for data the document is not stored in memory. The DOM API (Document Object Model API) is another parser interface for use by applications in accessing XML documents. The DOM API is particularly useful with smaller XML documents and acts to create and maintain in memory a copy of the XML document in the form of a tree structure. Each tag in the XML document is used to create a node and all attributes and text elements are also nodes in the tree. The DOM API provides a collection of methods which an application programmer can use to process the tree nodes including access data at the nodes, creating new nodes, and deleting nodes (e.g., elements in the XML document).

Existing methods and mechanisms for accessing markup language documents have a number of shortcomings and problems that need to be addressed to facilitate the use of markup language documents as the standard format for transmission of data within large enterprises and between individuals and businesses. Existing data access methods require extensive knowledge of the parser interfaces that can result in costly and time-consuming training of programmers. An application programmer needs to understand the markup language, such as XML, and also become familiar with the particular parser interface to be used, such as SAX API or DOM API. Additionally, the access method is tightly integrated with the access method or parser interface so that any changes to the access method or interface affect all of the applications using that access method or interface. This can be a problem as new versions of the parser or parser interface are implemented, with the applications using the parser being exposed to parser bugs. Further, the existing data access methods are tightly bound to the structure of a specific markup language document. A change to the underlying markup language document requires a change to every application accessing that document.

More specifically, the SAX API is an event-driven parser that acts to invoke start and end element functions as each tag is encountered during parsing. The application programmer using the SAX API is forced to provide code defining how each element in the markup language document is to be handled or processed. This requires a relatively large amount of coding for even simple documents. Additionally, the application is only useful for a specific document format, and the application cannot be readily used with other documents. When a change is made to the underlying document (such as addition of more data elements or deletion of a piece of data), every application accessing the document has to be revised to change the previously written code. Likewise, the DOM API creates a tree structure for a particular markup language document that can make it difficult to readily change the underlying document without affecting applications using the DOM API. The application programmer typically must spend a significant amount of their time writing code to access, extract, or manipulate the data in the markup language document including providing expected and accepted code to whichever parser or parser interface is implemented rather than concentrating their efforts on the functions and effectiveness of their application.

Hence, there remains a need for an improved method and system for accessing data in and manipulating markup language documents, such as XML documents. Preferably, such as method and system would decouple applications or higher level programs from the lower level data access mechanisms or document parsers, would reduce the effects of making changes to underlying markup language documents on the applications accessing the documents, and would utilize relatively standard data access commands or techniques to reduce the need for programmers to understand functioning of the data access method or document parsers.

### SUMMARY OF THE INVENTION

The present invention addresses the above problems by providing a data access method and system that markup language documents, such as SGML, HTML, and, particularly, XML documents, to be accessed by applications using standard database language commands. The system includes a data access mechanism or driver that is used by applications (e.g., financial, business to business, inventory, data mining, and other applications) to access data in, to modify, and in some cases, to create markup language documents. The data access driver is configured to accept standard database language commands, such as SELECT, UPDATE, DELETE, and INSERT commands or statements available in the Structured Query Language (SQL), and to return (when appropriate) results in tabular form such as in columns and rows. The data access driver dynamically maps or models the document to the received database language command or statement (e.g., the mapping is performed for each received statement). In one embodiment, this command mapping involves processing the received database commands to determine common parts in the command (such as a common prefix to an element in the document being accessed) and to use the smallest common part (or smallest prefix) found in each as a new result set or table with each addition to this smallest common part providing a row or column for the result set. In other words, the document is modeled as a database structure by using groups of elements as records or tables with each group of elements identified or related by a common prefix in their tag. The pointer is positioned at the beginning of records by identifying matches to this common prefix and then processing that element in the document.

The data access driver includes a database connectivity interface (such as an implementation of the Java Database Connectivity (JDBC) API provided by Sun Microsystems, Inc., an interface similar to the Open Database Connectivity (ODBC) method developed by Microsoft Corporation, or other database interface provided in these or other languages such as C++) that provides programmatic access to data structures modeled or mapped to a database structure (in this case XML or other markup language documents mapped as database structures) by enabling the driver to execute database language commands (such as SQL statements), to retrieve results from the data structures and return the results to applications, and to propagate changes back to an underlying data structure. Additionally, a parser is provided for parsing the markup documents based on the received database language commands. In one embodiment, the parser includes a pair of parsers or parser interfaces to facilitate efficient reading of the documents and to modify and create documents (e.g., a SAX API and a DOM API, respectively).

More particularly, a computer-based method is provided for accessing a markup language document. The method includes receiving a data access request from an application in the form of a database language statement and indicating the markup language document to be accessed. In one embodiment, the markup language document is formatted in XML and the database language statement is an SQL statement. The method continues with processing the data access request to identify the markup language document and then providing a communication connection to the markup language document. The markup language document is then accessed or processed based on the database language statement. In SQL embodiments, the statement may be a SELECT, an UPDATE, an INSERT, a DELETE, or other SQL statement, and the document is accessed to execute these SQL statements. A result set is then generated and returned to the application. Typically, the result set is in tabular form with data from the markup language document provided in rows and columns. The method includes dynamically mapping the markup language document to a database structure, i.e., to a number of records, based on the received database language statement. More particularly, the statements are processed to identify common tag prefixes (e.g., least common denominators) for the elements and providing a record for each such common tag or element prefix. During parsing, record pointers are positioned at the beginning of the mapped records in the markup language document by locating the common prefixes in the element tags and moving the record to this element.

### BRIEF DESCRIPTION OF THE DRAWINGS

FIG. 1 illustrates in block diagram form a data access system in which the present invention is implemented;

FIG. 2 illustrates in block diagram form a portion of a data access system (such as the system of FIG. 1) during operation of the data access driver to process a database language command, to access a markup language document based on the database language command or statement, and to return a tabular result set to an application; and

FIG. 3 is a flow chart illustrating functions performed by a data access driver during a data access operation.

### DETAILED DESCRIPTION OF THE PREFERRED EMBODIMENTS

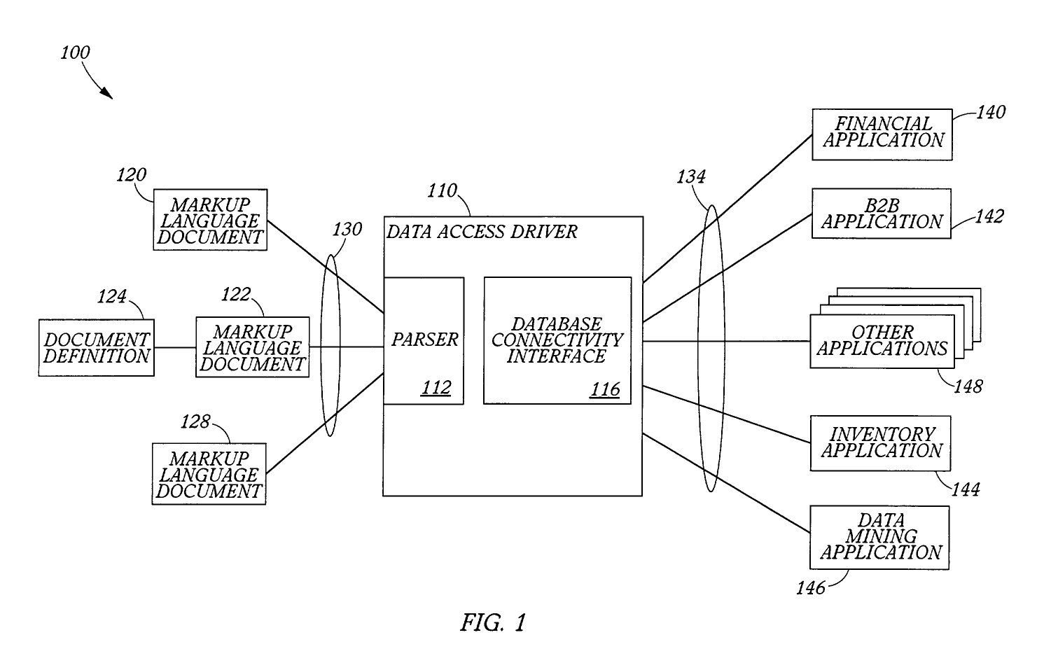

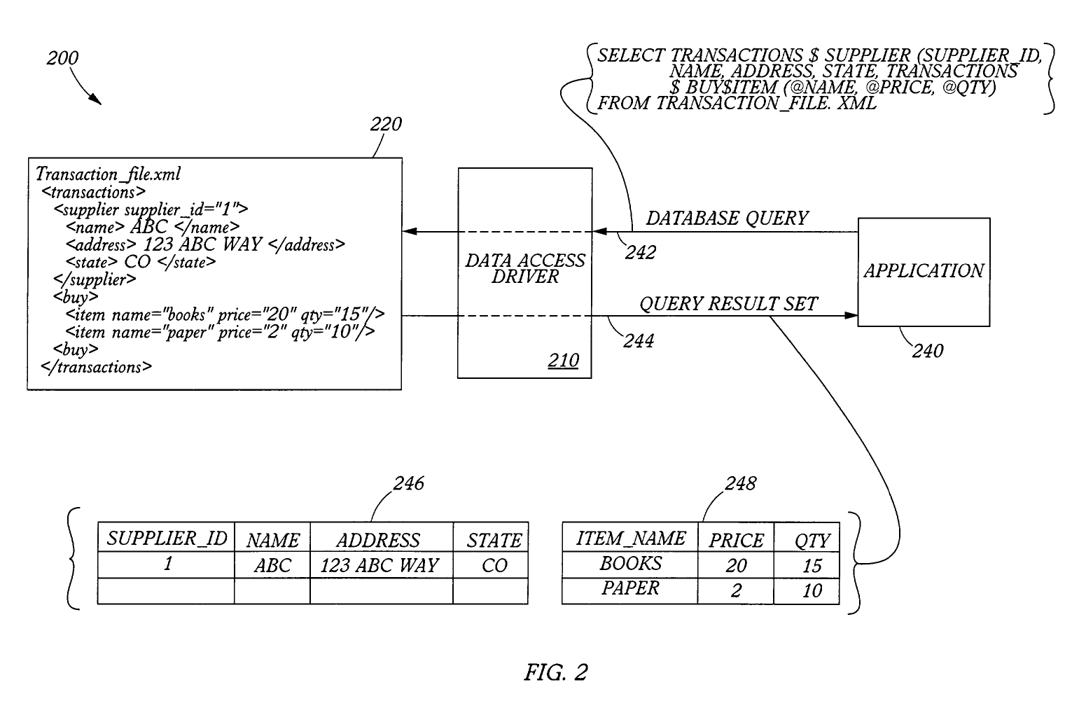

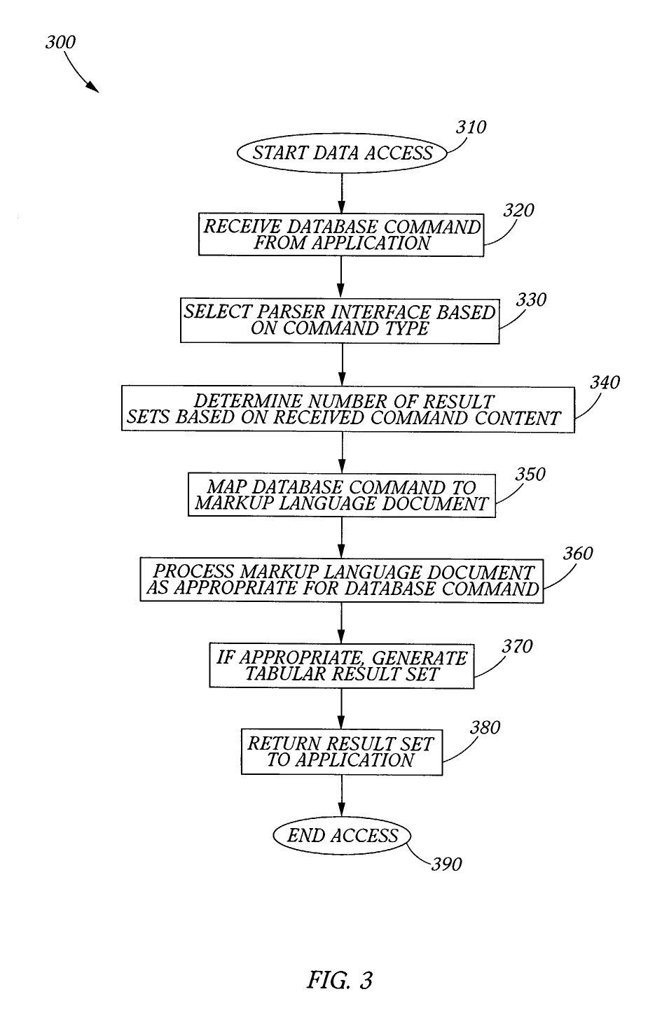

In general, the present invention is directed to a method and system for accessing markup language documents or data sources with standard or well-known database commands, such as, but not limited to SQL statements. The following discussion first provides a general overview of a data access system according to the invention with reference to FIG. 1, then proceeds to describe in more detail functions of the data access driver or mechanism of the invention which provides a bridge between applications and markup language documents with reference to FIG. 2, and then provides a description of exemplary operations of a data access system with reference to FIG. 3. To provide a detailed explanation of the mapping of a markup document to a database or database-like structure, the following descriptions utilize markup documents that are XML documents and database language commands that are SQL statements. However, once the method of accessing XML documents with SQL statements is understood, those skilled in the arts will readily appreciate the applications of the invention to nearly any markup language document and to numerous database language commands, queries, and/or statements.

FIG. 1 illustrates in schematic form a data access system 100 according to the invention. A data access driver 110 is included to provide a bridge between markup language data sources and any applications attempting to access these data sources. As illustrated, the date sources are markup language documents 120, 122, and 128 which can be located at one or more locations or devices, such as Web servers, linked to the data access driver 110 by the Internet or other data communication networks or links 130. While the documents 120, 122, 128 may be created according to any of a number of markup languages, XML has recently become the format of choice for storing and exchanging information and in many embodiments, the documents 120, 122, 128 are XML documents. Typically, the documents 120, 122, 128 have different formats and different elements (defined by markups or tags) with document 122 being defined by a document definition 124 (such as an XML document type definition (DTD) or XML schema). Significantly, a single data access driver 110 can be used to access the three (or more not shown) documents 120, 122, 128 rather than a specific application being written for or tied to a specific document and document format and content.

The data access driver 110, which also may be run on or provided on a server, is linked via links 134 (e.g., the Internet or other digital communication links) to a number of applications running on one or more servers or other electronic devices. As shown, the applications include a financial application 140, a business-to-business application 142, an inventory application 144, a data mining application 146 (such as an Brio, Cognos, or other applications used for OLAP), and other applications 148. Each of these applications 140, 142, 144, 146, 148 implements or communicates with the data access driver 110 via the links 134 to obtain access to, modify, or create the markup language documents 120, 122, 128. As will be explained in more detail, the applications 140, 142, 144, 146, 148 use standard database commands, such as SQL statements, to access the documents 120, 122, 128 and in return, receive tabular result sets. In other words, the applications 140, 142, 144, 146, 148 do not need to be aware of the data access or handling techniques used by the data access driver 110 in accessing the documents 120, 122, 128 and do not even need to know that the documents 120, 122, 128 are markup language documents rather than database structures.

The data access driver 110 includes or implements a database connectivity interface or mechanism 116 for providing a connection with the documents 120, 122, 128, for executing all the database language statements received from the applications 140, 142, 144, 146, 148, and for returning a result set over link 134. The data access driver 110 can be programmed in a number of languages including Java™, C++, and the like and the interface 116 may be selected to support the underlying language of the driver 110 (such as a JDBC API, ODBC interface, or other useful interface). In one embodiment, the data access driver 10 is provided in the Java programming language and implements the JDBC API and a number of its interfaces or methods in the database connectivity interface 116. For example, JDBC API interfaces and/or methods (such as Statement, Connection, PreparedStatement, ResultSet, ResultSetMetaData, and the like) are implemented to specify the directory of the markup language documents 120, 122, 128, to execute database language commands (such as SQL statements including SELECT, UPDATE, INSERT, DELETE, and others), and return result sets based on commands.

The parser 112 is included in the data access driver 110 to parse the markup language documents 120, 122, 128 and in some embodiments, to modify or even create the documents 120, 122, 128. The parser 112 may implement one or more known parsing tools or interfaces to providing the parsing functions described for the driver 110. For example, the parses 112 may implement a first parser tool useful for efficiently reading or documents 120, 122, 128 and a second parser tool useful for modifying and/or creating documents 120, 122, 128. In one embodiment, the parser 112 includes both (or implements) a SAX API and a DOM API (while in some cases, either one of these may be used individually), respectively, to provide parsing functions. The data access driver 110 is configured to support the SAX API and the DOM API and to utilize the appropriate parsing interface depending on the received database command, e.g., to use the SAX API for simple queries (such as an SQL SELECT statement) and the DOM API for more complex commands (such as SQL DELETE, INSERT, and UPDATE statements).

The methods and/or functions of the invention can be implemented using numerous electronic and computer devices (e.g., a variety of hardware) and with one or more applications or software programs useful for performing the underlying, described tasks (e.g., Web browsers, text editors, graphical user interfaces, communication managers, database and memory managers, and many more software tools well-known in the computer arts). Computer and network devices, software tools, drivers, and applications, and stored data and documents, such as documents 120, 122, 128, data access driver 110, parser 112, interface 116, and applications 140, 142, 144, 146, 148, are described in relation to their function rather than as being limited to particular electronic devices and computer architectures, programming languages, and data storage structures and devices. To practice the invention, the components of system 100 (and system 200 of FIG. 2) may be any devices, software modules or routines, and data structures useful for providing the described functions, including well-known data processing and communication devices and systems such as personal digital assistants, personal, laptop, and notebook computers with processing, memory, and input/output components, and server devices configured to maintain and then transmit digital data over a communications network. Data, including client requests and service provider responses, is typically communicated in digital format following standard communication and transfer protocols, such as TCP/IP, HTTP, HTTPS and the like, but this is not intended as a limitation of the invention.

FIG. 2 illustrates a data access system 200 (similar to portions of system 100) that illustrates in more detail the operation of the system 200 and simple but illustrative examples of communications between an application and a data access driver during a data access operation. The following example involves accessing a markup language document 220 that as illustrated is a simple XML document that may be stored or located on a Web server or other device accessible by the data access driver 210 over a communication network, such as the Internet, or by other methods. The invention is not limited to XML documents but is very useful with these popular markup language documents used for structuring documents. The XML document includes a number of tags (i.e., transactions, supplier, name, address, state, buy, and item) to identify units of information or elements. The tags can be nearly any useful string of characters with “<” and “>” being used as a prefix and suffix, respectively, to identify the tags. XML enables the grouping of individual pieces of data or elements using tags to make relations or sets of data elements. For example, in the document 220, the transaction group or set of information can be thought of as containing two subsets of elements (i.e., the supplier information set of elements and the buy set of information). Information in XML documents, such as document 220, can also be stored as attributes of a particular tag, e.g., attributes for item include a name, a price, and a quantity. As explained previously, it is desirably for the system 200 to be configured to allow access to the XML document 220 without an in-depth knowledge of XML or even of the specific data handling or access techniques used by the data access driver 210.

The system 200 is configured to allow the XML document 220 to be accessed by application 240 with a database query 242 and to receive in return a query result set 244 that is readily understood by the application 240. As discussed with reference to FIG. 1, the data access driver 210 typically includes a database connectivity interface to allow it to receive a database language statement 242, to connect to data sources (such as XML document 220), and to return a result set 244 that is in tabular form (such as a table having rows and columns). The data access driver 210 also includes a parser (such as one or more parser interfaces including, but not limited to, a SAX API and a DOM API) that is useful for reading and understanding the XML document 220 and, in some cases, modifying or even creating the document 220. By configuring the data access driver 210 for communicating with the application 240 with database language commands 242, 244, the driver 210 (or database-like interface to the XML document 220) makes the application 240 independent of the parsers used to access the XML document and the developer of the application 240 can concentrate on application-specific logic rather than data handling logic.

While numerous database languages can be used, one embodiment of the system 200 utilizes SQL because SQL is nearly an industry-wide standard and its syntax and usage is well known to a majority of application programmers. Hence, the database query or access statement 242 is typically a SQL statement (such as SELECT, DELETE, INSERT, and UPDATE). In SQL, the basic philosophy is to operate on data in a relational database without regard or knowledge of the underlying database management system or the specific organization of data in the database. SQL is useful in system 200 because the user (or application 240) can specify operations or statements (like a SELECT statement) without having to specify the steps required by the driver 210 or other device to perform that operation. The driver 210 takes SQL input statement 242, parses the statement 242, and returns data from the XML document 220 as strings and numbers to the application 240 variables.

To better explain the data access method of the invention, an exemplary database language statement 242 and result set 244 is shown in FIG. 2. The driver 210 is configured to take SQL input statements in the general form of “SQL COMMAND tagname$childtag FROM documentname WHERE tagname$childtag=‘xyz’”. The “$” character is used as a statement separating character in many XML embodiments because the “.” character has a specific meaning in XML. The statement separating character can be any of a number of other characters. For example, the “.” Character can be used by using a slightly different syntax for the database statement 242, such as placing portions of the identifier in double quotes (i.e., “SELECT “tagname.childtag” FROM documentname”). In these examples, the SQL statements map or use the name of the document 220 in the position in which a name of a table is usually provided in SQL statements. The other SQL commands would have similar syntax to map these types of statements to an XML document. The syntax for DELETE would be “DELETE documentname WHERE tagname$childtag=‘xyz’”. The syntax for UPDATE would “UPDATE documentname SET tagname$childtag$grandchild1=‘abc’ WHERE tagname$childtag$grandchild2=‘xyz’”. The syntax for INSERT is “INSERT INTO documentname (tagname$childtag(grandchild1, grandchild2, grandchild3)) VALUES (‘abc’, ‘def’, ‘ghi’). Other syntax can also be used to implement the system 200 and the WHERE clause can be readily implemented and multiple SQL expressions can be combined with logical operators (e.g., “AND”, “OR”, and other SQL operators).

A significant feature of the invention and system 200 is providing a method of mapping a database-like structure (i.e., tables with rows and columns) to the XML nested tag structure (or mapping an XML document to a database structure). The mapping can be relatively simple when the relation of data is one-to-one in a given XML structure and where there is only one type or group of information in the XML structure. However, XML has gained popularity because it handles multiple groups of information in the same document, as is the case in document 220. As illustrated, the XML document 220 includes transaction information for a given supplier while also holding information regarding the supplier themselves (and of course, much more complicated XML documents 220 can be envisioned with more complex nesting and inclusion of numerous types and groups of information). As can be appreciated, it would be difficult to map the document 220 with multiple information groups to a single database structure or table.

In one embodiment, the mapping of multiple information group documents, like document 220, is performed by the driver 210 by mapping or modeling these documents with a number of tables equal to the number of information groups. Significantly, the number of information groups in the document is determined by the driver 210 by processing the database query 242. Once the number of information groups is identified (such as by determining the smallest common portion of the statement), the data access driver 210 acts to position the record pointer to the beginning of a record and read the record (e.g., the correct portion or group of information from the XML document 220).

Returning to the example shown in FIG. 2, the database language statement 242 is a SQL statement (i.e., a SELECT). The data access driver 210 processes the statement 242 along with the XML document 220 to dynamically map the XML document to one or more database structures and to return the result set 244. As shown, the data access driver 210, based on the database statement or SQL SELECT 242 determines that the document 220 can be mapped or modeled as two tables, i.e., a “transactions$supplier” table 246 and a “transactions$buy” table. The driver 210 determines from the query 242 and the XML document 220 that these are the lowest common element or “denominator” in the document 220. The data access driver 210 then uses a parser (such as parser 112 of FIG. 1) to read the XML document 220 and return the result set 244 including two tables 246, 248 having columns for each attribute or lowest level element and rows for the elements above this lowest level element or attribute in each table 246, 248. The result set 244 is in a form readily understood and useable by SQL programmers. The method of parsing or handling information in the document 220 is separated from the application 240 and when the XML document changed the application 240 needs only be changed in its affected SQL statements (such as the database language statements 242). Changes to the underlying data handling methods, parsers, or mechanisms used by the data access driver 210 are also isolated from the application 240 which only responsible for providing the SQL statements 242 and processing the result sets 244.

In addition to the SELECT statement, the application 240 may transmit other SQL statements as statement 242 to modify or create the document 220 (such as DELETE statements to delete node or elements in the XML document 220, UPDATE statements to change values in the document 220, and INSERT to add nodes or elements to the document 220). The use of these modification and element creation statements enables the application 240 to use database language commands (such as SQLs) to manipulate data in an XML or other markup language document 220. Significantly, the data access driver 210 facilitates programmers and users unfamiliar with XML or other markup languages to work with and create these types of documents 220 with SQL or other database language statements that they may be more familiar.

Referring now to FIG. 3, a data access method 300 is illustrated to further describe the functions performed by systems (such as systems 100 and 200) to allow applications to access XML and other markup language documents using database language commands. The data access process 300 is started at 310 with connections between applications and a data access driver (such as Internet connections) or the driver can be installed on the same application server as the application. At 310, the driver is configured with one or more interfaces to allow it to receive and process database language statements, such as an JDBC API or an ODBC API to allow the driver to accept and process SQL statements from an application. Additionally at 310, a parser mechanism is configured for providing data handling functions. In one embodiment, the parser mechanism includes a SAX API for performing read or data access functions and a DOM API for performing document modifications and creation functions.

At 320, a database language statement is received from an application at the driver. The driver, via its database connectivity interface or otherwise, begins to process the received statement. At 330, the driver selects a parser interface or parser functions based on the statement-type. For example, a SAX API may be selected for SQL SELECT commands and a DOM API for SQL DELETE, INSERT, and UPDATE commands in an SQL environment. At 340, the driver continues to process the received database language statement to determine number of result sets based on the received command or more specifically, the number of tables to be included in the result set(s). At 350, the driver acts to map or model the markup language document to the database language statements (such as the two tables 246, 248 shown in FIG. 2). To determine the record structure, a list of document elements (such as XML elements) is made and the common prefixes for the groups of elements is determined (with more than one table or record being used if more than one common prefix is found). The driver acts to create a data definition or mapping of the markup language document that is specific to the particular database language statement.

Note, the mapping or modeling of the XML or other markup language document as a database structure is an important feature of the invention and can be performed in a number of ways to practice the invention. The use of the “least common denominator” technique or smallest common portion found in tags is just one useful example of how mapping may be performed and other mapping techniques will become apparent to those skilled in the art once the described mapping technique is understood.

At 360, the markup language document identified in the statement received from the application is processed as required by the statement (e.g., read for an SQL SELECT or modified for an SQL UPDATE, DELETE, or INSERT). The pointer is positioned at the beginning of the record to process the appropriate portion of the document. For example, when using a SAX parser to process a received query, each element is read and when a match is achieved for the particular common prefix, a beginning of a record is identified and the pointer positioned at this matched element. The pointer is then repositioned in the document for each common prefix identified and the process repeated.

If appropriate ate 370, the result set is generated (such as a tabular result set for a SELECT). At 380, the result set is transmitted to the requesting application. The access method 300 is ended at 390. Of course, in practice, numerous database statements (at 320) may be received and processed concurrently by the driver from one or more applications to access one or more documents. Significantly, a single implementation of the driver can be used to access differently formatted markup language documents as the received database language statements are processed to dynamically determine how the document is to be processed (and with what parsers or parser interfaces) and to determine the form of the generated and returned result set.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. The data access method of the present invention addresses the fact that markup languages such as XML differ from relational databases because the markup language documents have no concept similar to records and record types or tables and instead numerous information types and elements can be included in a single document and in a complex nested manner. The data access method addresses this complexity by modeling or mapping the markup language document by using a group of elements as a record. The record structure is dynamically determined based on the database language statement (such as an SQL statement). The record pointer is then pointed at the beginning of the record (the tag that starts a particular group of elements) and the record read or otherwise processed based on the database language statement.

We claim:

1. A computer-based method for accessing a markup language document, comprising:
receiving a data access request from an application including an identifier for a markup language document and a database language statement;
processing the data access request to identify the markup language document;
providing a connection to the markup language document;
accessing the markup language document based on the database language statement; and
returning a result set to the application including data from the markup language document.

2. The method of claim 1, wherein the document is formatted in the eXtensible Markup Language (XML).

3. The method of claim 1, wherein the database language statement is a Structured Query Language (SQL) statement.

4. The method of claim 3, wherein the database language statement is selected from the group consisting of select, delete, update, and insert.

5. The method of claim 1, wherein the processing of the data access request includes identifying common prefixes for information elements in the markup language document and further including mapping the markup language document to a database structure having records corresponding to the identified common prefixes.

6. The method of claim 5, wherein the accessing includes locating a tag that matches one of the common prefixes in the markup language document and positioning a record pointer at the matched tag, whereby the record pointer is positioned at a start of one of the records.

7. The method of claim 5, wherein the result set is formatted in tabular form with columns corresponding to elements nested within the elements having identified common prefixes.

8. The method of claim 1, wherein the accessing of the markup language document includes parsing with a first or a second parser and further including selecting the first or the second parser based on the database language statement.

9. The method of claim 8, wherein the first parser comprises a Simple Application Programming Interface (API) for XML.

10. The method of claim 8, wherein the second parser comprises a Document Object Model API.

11. A data access driver for use by applications in accessing markup language documents, comprising:
a database connectivity interface receiving data access requests identifying a markup language document and having a database query format, providing connections to the markup language documents, and executing commands in the data access requests; and
a parser mechanism parsing the markup language documents based on the commands in the data access requests.

12. The method of claim 11, wherein the database connectivity interface is adapted for mapping the markup language documents to database structures having records comprising a group of elements in the markup language documents.

13. The method of claim 12, wherein the mapping includes processing the commands in the data access requests to determine common prefixes for elements in the markup language documents and wherein the groups of elements for the records are selected based on tags in the markup language document that match the common prefixes.

14. The system of claim 13, wherein the parser mechanism includes a first parser for parsing involving data retrieval from the markup language documents and a second parser for parsing involving modifying or creating the markup language documents.

15. The system of claim 14, wherein the first parser comprises a Simple Application Programming Interface (API) for XML and wherein the second parser comprises a Document Object Model API.

16. The system of claim 11, wherein the database query format is defined by Structured Query Language (SQL).

17. The system of claim 11, wherein the database connectivity interface further functions to generate and return result sets based on the parsing performed by the parser mechanism and including data in columns representing elements in the markup language documents.

18. The system of claim 11, wherein the markup language documents are extensible Markup Language (XML) documents.

19. A computer readable medium, comprising:
computer readable program code devices configured to cause a computer to effect receiving from an application a data access request identifying a markup language document and defining processing of the markup language with a database language statement;
computer readable program code devices configured to cause a computer to effect processing the data access request to provide a connection to the markup language document;
computer readable program code devices configured to cause a computer to effect parsing the markup language document based on the database language statement; and
computer readable program code devices configured to cause a computer to effect generating a result set to the data access request and transmitting the result set to the application.

20. The computer readable medium of claim 19, further including computer readable program code devices configured to cause a computer to effect mapping the markup language document to a database structure having records each containing a group of information elements from the markup language document.

21. The computer readable medium of claim 20, wherein the mapping includes processing the database language statement to identify one or more common prefixes and wherein one of the records of the database structure is provided for each of the common prefixes.

22. The computer readable medium of claim 21, wherein the common prefixes comprise two or more element labels separated by a character recognizable by the mapping code devices.

23. The computer readable medium of claim 20, wherein the parsing includes finding matches for the one or more common prefixes in the element tags in the markup language document and positioning a record pointer for the one of the records provided for the matched common prefix.

24. The computer readable medium of claim 19, wherein the database language statement is a SQL statement and the markup language document is an XML document.
